(19) United States
(12) Patent Application Publication
(10) Pub. No.: US 2024/0321507 A1
(43) Pub. Date: Sep. 26, 2024

(54) THREE-DIMENSIONAL (3D) INDUCTOR WITH TWO-SIDE BONDING WIRES

(71) Applicant: QUALCOMM Incorporated, San Diego, CA (US)

(72) Inventors: Kai LIU, Phoenix, AZ (US); Jui-Yi CHIU, Taichung City (TW); Jonghae KIM, San Diego, CA (US)

(21) Appl. No.: 18/189,325

(22) Filed: Mar. 24, 2023

(51) Int. Cl. H01F 27/28; H01F 27/24; H01F 27/29; H01F 27/32; H01F 41/069; H01F 41/10; H01F 41/12

(52) U.S. Cl. CPC H01F 27/2866; H01F 27/24; H01F 27/29; H01F 27/327; H01F 41/069; H01F 41/10; H01F 41/127

(57) ABSTRACT

Disclosed is a three-dimensional (3D) inductor with two-side bonding wires. The 3D inductor enables high inductance to be achieved, e.g., for integrated voltage regulators (IVR) and/or external voltage regulators (EVR). The inductance of the 3D inductor can be enhanced with magnetic molding compounds.

### FIELD OF DISCLOSURE

This disclosure relates generally to integrated circuits, and more specifically, but not exclusively, to integrated circuits with three-dimensional (3D) inductors, such as 3D magnetic inductors, with two-side bonding wires, and fabrication techniques thereof.

### BACKGROUND

Integrated circuit technology has achieved great strides in advancing computing power through miniaturization of active components. The devices, such as semiconductor devices, can be found in many electronic devices, including processors, servers, radio frequency (RF) integrated circuits, etc.

In RF front end (RFFE) applications (e.g., transformers, couplers, etc.), use of inductors is very high. In some applications, e.g., switching frequencies for power management IC, large inductances are desired. Also, external inductors can be costly.

Accordingly, there is a need for systems, apparatus, and methods that overcome the deficiencies of conventional integrated circuits with inductors including the methods, system, and apparatus provided herein.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

An exemplary three-dimensional (3D) inductor is disclosed. The 3D inductor may comprise a plurality of first leads on a first side of the inductor. The 3D inductor may also comprise one or more second leads on a second side of the inductor opposite the first side. The 3D inductor may further comprise one or more upper wires. Each upper wire may electrically couple an upper surface of a second lead with an upper surface of a first lead. The 3D inductor may yet comprise one or more lower wires. Each lower wire may electrically couple a lower surface of one first lead with a lower surface of one second lead. The 3D inductor may yet further comprise an upper mold. The upper mold may at least partially encapsulate the plurality of first leads. The upper mold may also at least partially encapsulate the plurality of second leads. The upper mold may further encapsulate the one or more upper wires. The 3D inductor may additionally comprise a lower mold encapsulating the one or more lower wires. The plurality of first leads, the one or more second leads, the one or more upper wires, and the one or more lower wires may be configured to form one or more loops of the 3D inductor.

An exemplary method of fabricating a three-dimensional (3D) inductor is disclosed. The method may comprise forming a plurality of first leads on a first side of the inductor. The method may also comprise forming one or more second leads on a second side of the inductor opposite the first side. The method may further comprise forming one or more upper wires. Each upper wire may electrically couple an upper surface of a second lead with an upper surface of a first lead. The method may yet comprise forming one or more lower wires. Each lower wire may electrically couple a lower surface of one first lead with a lower surface of one second lead. The method may yet further comprise forming an upper mold. The upper mold may at least partially encapsulate the plurality of first leads. The upper mold may also at least partially encapsulate the plurality of second leads. The upper mold may further encapsulate the one or more upper wires. The method may additionally comprise forming a lower mold encapsulating the one or more lower wires. The plurality of first leads, the one or more second leads, the one or more upper wires, and the one or more lower wires may be configured to form one or more loops of the 3D inductor.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1A illustrates a perspective view of an example of 3D inductor in accordance with or more aspects of the disclosure.

FIG. 1B illustrates a cross sectional view of an example of 3D inductor in accordance with or more aspects of the disclosure.

FIGS. 2A-2G illustrate example stages of fabricating a 3D inductor in accordance with or more aspects of the disclosure.

FIGS. 3 and 4 illustrate flow charts of example methods of manufacturing a 3D inductor in accordance with at one or more aspects of the disclosure.

FIG. 5 illustrates various electronic devices which may utilize one or more aspects of the disclosure.

Other objects and advantages associated with the aspects disclosed herein will be apparent to those skilled in the art based on the accompanying drawings and detailed description. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Aspects of the present disclosure are illustrated in the following description and related drawings directed to specific embodiments. Alternate aspects or embodiments may be devised without departing from the scope of the teachings herein. Additionally, well-known elements of the illustrative embodiments herein may not be described in detail or may be omitted so as not to obscure the relevant details of the teachings in the present disclosure.

In certain described example implementations, instances are identified where various component structures and portions of operations can be taken from known, conventional techniques, and then arranged in accordance with one or more exemplary embodiments. In such instances, internal details of the known, conventional component structures and/or portions of operations may be omitted to help avoid potential obfuscation of the concepts illustrated in the illustrative embodiments disclosed herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

As indicated above, inductors are useful. In many instances, acquiring inductors with sufficient inductance can be costly. To address these and other issues, it is proposed to provide a three-dimensional (3D) inductors with two-side (or double-side) bonding wires. Compared to one-side bonding wire inductors, the proposed 3D inductors with two-side bonding wires can more than double the inductance (e.g., from ˜155 nH to ˜350 nH).

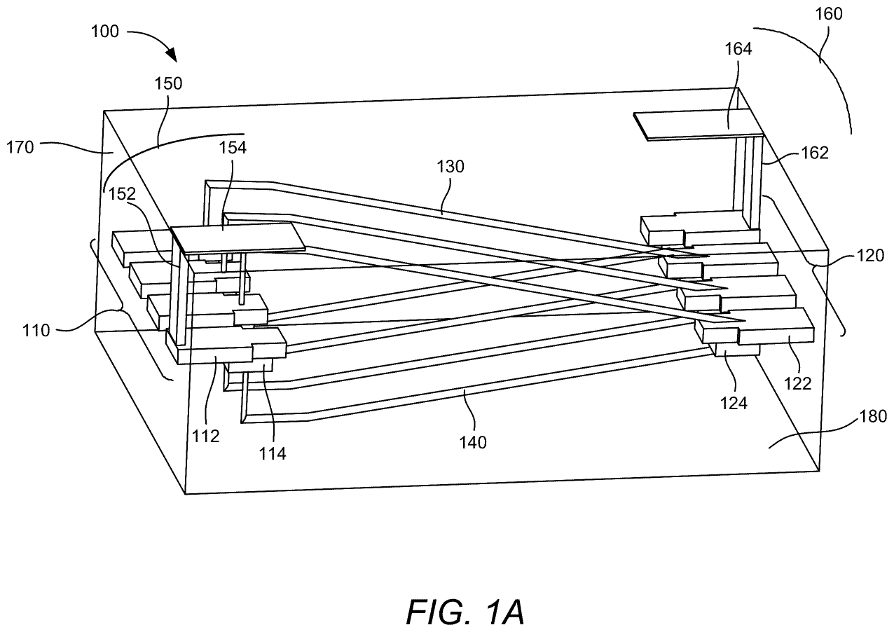

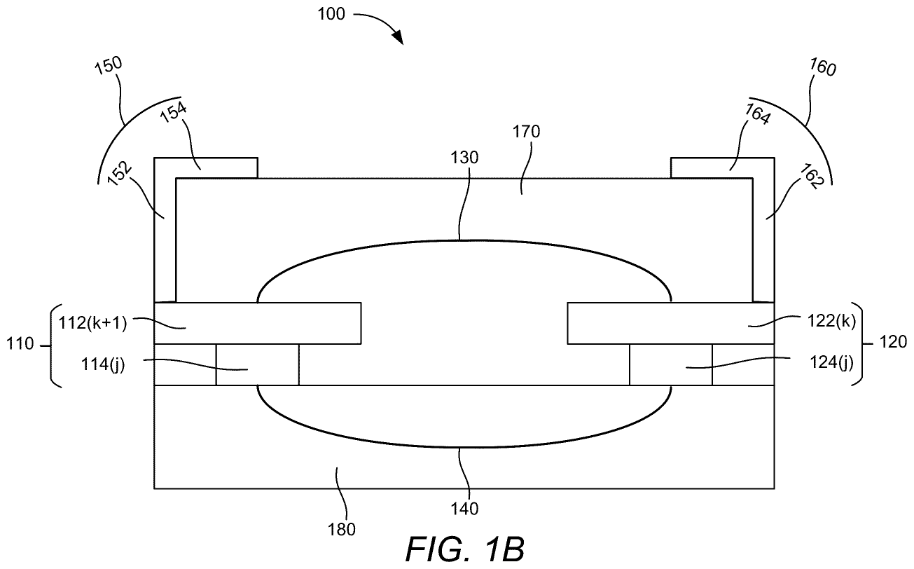

FIG. 1A illustrates a perspective view and FIG. 1B illustrates a cross sectional view of an example of 3D inductor 100 in accordance with or more aspects of the disclosure. As seen, the proposed 3D inductor 100 may include a plurality of first leads 110 on a first side of the inductor 100. The number of first leads 110 is four in this instance (see FIG. 1A). However, this is merely an example. The number of first leads 100 may be N, where N is two or more, i.e., N≥2.

In an aspect, each first lead 110 may comprise a first upper lead 112 and a first lower lead 114. Thus, there may be a plurality of first upper leads 112 (N of them) and a plurality of first lower leads 114 (N of them). Each first upper lead 112 may be on and electrically coupled with a corresponding first lower lead 114. For example, the first upper leads 112 may be in physical contact with the first lower leads 114. Thus, upper surfaces of the first upper leads 112 may be considered to be upper surfaces of the first leads 110. Conversely, lower surfaces of the first lower leads 114 may be considered to be lower surfaces of the first leads 110. The first upper and/or lower leads 112, 114 may be formed from conductive materials such as copper (Cu), silver (Ag), aluminum (Al), etc.

It should be noted that terms and phrases such as “upper”, “lower”, “top”, “bottom”, “left”, “right”, and so on are merely used for convenience of description. Unless explicitly stated otherwise, such terms and phrases should not be taken to indicate absolute orientations.

The 3D inductor 100 may include one or more second leads 120 on a second side of the inductor 100, which is opposite the first side. The number of second leads 120 is also four in this instance (see FIG. 1A). Again, this is merely an example. The number of second leads 100 may be M, where M is one or more, i.e., M≥1.

In an aspect, each second lead 120 may comprise a second upper lead 122 and a second lower lead 124. Thus, there may be one or more second upper leads 122 (M of them) and one or more second lower leads 124 (M of them). Each second upper lead 122 may be on and electrically coupled with a corresponding second lower lead 124. For example, the second upper leads 122 may be in physical contact with the second lower leads 124. Thus, upper surfaces of the second upper leads 122 may be considered to be upper surfaces of the second leads 110. Conversely, lower surfaces of the second lower leads 124 may be considered to be lower surfaces of the second leads 120. The second upper and/or lower leads 122, 124 may be formed from conductive materials such Cu, Al, etc.

The 3D inductor 100 may also include one or more upper wires 130. The number of upper wires 130 is three in this instance. More generally, there may be N−1 upper wires 130. The upper wires 130 may be formed from materials such as copper, aluminum, gold, silver, etc.

Each upper wire 130 may electrically couple an upper surface of a second lead 120 with an upper surface of a first lead 110. For example, an end of one upper wire 130 may physically contact an upper surface of one second lead 120 (e.g., upper surface of one second upper lead 122) and other end of that same upper wire 130 may physically contact an upper surface of one first lead 110 (e.g., upper surface of one first upper lead 112). More particularly, assume that each first lead 110 may be identified with an index. That is first lead (1) may represent the first of the first leads 110 and first lead (N) may represent the last of the first leads 110. Similarly, each second lead 120 may also be identified with an index. For example, second lead (1) may represent the first of the second leads 120 and second lead (M) may represent the last of the second leads 120. Then in an aspect, each upper wire 130 may electrically couple an upper surface of a second lead (k) to an upper surface of a first lead (k+1), where k=1 . . . N−1 (indicated in FIG. 1B).

The 3D inductor 100 may include one or more lower wires 140. The number of lower wires 140 is four in this instance. More generally, there may be M upper wires 130. The lower wires 140 may be formed from materials such as copper, aluminum, gold, silver, etc.

Each lower wire 140 may electrically couple a lower surface of a first lead 110 with a lower surface of a second lead 120. For example, an end of one lower wire 140 may physically contact a lower surface of one first lead 110 (e.g., lower surface of one first lower lead 112) and other end of that same lower wire 140 may physically contact a lower surface of one second lead 120 (e.g., lower surface of one second upper lead 122). Then in an aspect, each lower wire 140 may electrically couple a lower surface of a first lead (j) to a lower surface of a second lead (j), where j=1 . . . M (indicated in FIG. 1B).

The plurality of first leads 110, the one or more second leads 120, the one or more upper wires 130, and the one or more lower wires 140 may be configured to form one or more loops of the 3D inductor 100. For example, each turn of the inductor 100 may be configured through first lead k, lower wire k, second lead k, and first lead k+1. FIG. 1A illustrates an instance in which there are three and half loops.

An upper mold 170 and a lower mold 180 may encapsulate the first and second leads 110, 120 and the upper and lower wires 130, 140. In particular, the upper mold 170 may encapsulate the plurality of first leads 110, the plurality of second leads 120, and the one or more upper wires 130. In an aspect, side surfaces of the first leads 110 (e.g., side surfaces of the first upper leads 112) and side surfaces of the second leads 120 (e.g., side surfaces of the second upper leads 122) may be exposed. For example, side surfaces of the first upper leads 112 (on first side) and side surfaces of the second upper leads 122 (on second side) may be planar with the first and second side surfaces of the upper mold 170. That is, in an aspect, the upper mold 170 may encapsulate the plurality of first leads 110, at least in part. Alternatively or in addition thereto, the upper mold 170 may encapsulate the plurality of second leads 120, at least in part. The lower mold 180 may encapsulate the one or more lower wires 140.

It is contemplated that the upper mold 170 and/or the lower mold 180 can be formed from epoxy materials. However, to enhance inductance, it may be preferred that the upper mold 170 be formed from first magnetic molding compounds. Alternatively or in addition thereto, it may also be preferred that the lower mold 180 be formed from second magnetic compounds, which may be same or different from the first magnetic compounds. The first and/or the second magnetic compound may be formed from any of polymer bonded compound, ferrite-bonded compound, isotropic neodymium bonded compound, anisotropic isotropic neodymium-bonded compound, samarium-cobalt bonded compound, etc.

To enable connections with external devices, the 3D inductor 100 may include a first terminal 150 electrically coupled to one end of the inductor loops, and a second terminal 160 electrically coupled to the other end of the inductor loops. In an aspect, the first terminal 150 may be electrically coupled to an upper surface of the first of the plurality of first leads 110 (e.g., first of the first upper leads 112). For example, the first terminal 150 may be contact with an upper surface of first lead n=0.

The first terminal 150 may comprise a first side plate 152 formed on a side surface of the upper mold 170. A lower part of the first side plate 152 may be coupled to, e.g., in contact with, the upper surface of the first of the plurality of first leads 110 (i.e., first lead n=1). The first terminal 150 may also comprise a first pad 154 formed on an upper surface of the upper mold 170 and connected with the first side plate 152. For example, the first side plate 152 and the first pad 154 may be integrally formed. The first terminal 150 may be formed from any one or more of copper, silver, and aluminum.

Similarly, the second terminal 160 may be electrically coupled to an upper surface of the last of the one or more second leads 120 (e.g., last of the second upper leads 122). For example, the second terminal 160 may be contact with an upper surface of second lead m=M.

The second terminal 160 may comprise a second side plate 162 formed on the side surface of the upper mold 170. A lower part of the second side plate 162 may be coupled to, e.g., in contact with, the upper surface of the last of the one or more second leads 120 (i.e., second lead m=N). The second terminal 160 may also comprise a second pad 164 formed on the upper surface of the upper mold 170 and connected with the second side plate 162. For example, the second side plate 162 and the second pad 164 may be integrally formed. The second terminal 160 may be formed from any one or more of copper, silver, and aluminum.

FIGS. 1A and 1B illustrate a situation in which there are equal number of the first and second leads 110, 120 (four in this instance). When numbers of first and second leads 110, 120 are the same, e.g., when N=M, in such instances, the first end of the inductor loops may be the first of the first leads 110 (i.e., first lead n=1), and the second end of the inductor loops may be the last of the second leads 120 (i.e., second lead m=M).

But in another embodiment (not shown), the number of first and second leads 110, 120 need not be equal. That is, N and M need not be the same. In particular, there may be one less second leads 120 than the first leads 110, i.e., M=N−1. There still would be N−1 upper wires 130, and each upper wire 130 may electrically couple an upper surface of a second lead (k) to an upper surface a first lead (k+1), k=1 . . . N−1. There would also still be M lower wires 140, and each lower wire (j) may electrically couple a lower surface of a first lead (j) to a lower surface of a second lead (j), j=1 . . . M. However, since M=N−1, the last of the first leads 110—i.e., first lead (N)—would not have connection with any of the lower wires 140. In this instance, the second terminal 160 may be electrically coupled to an upper surface of the last of the plurality of first leads 110, i.e., to the upper surface of the first lead (N).

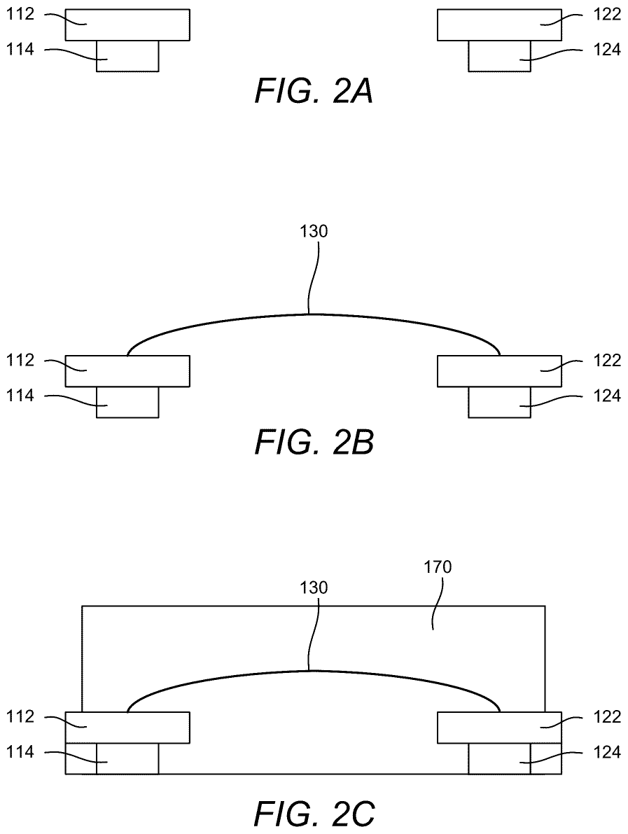

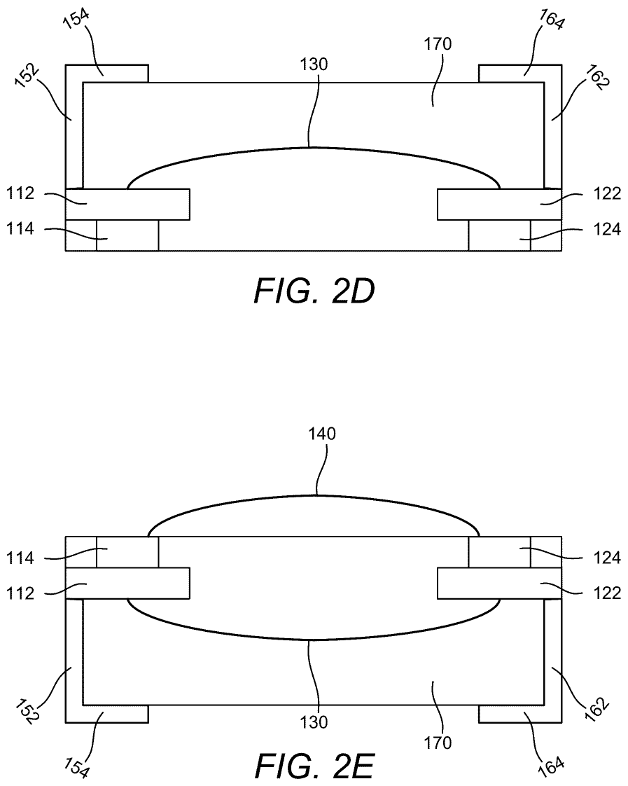

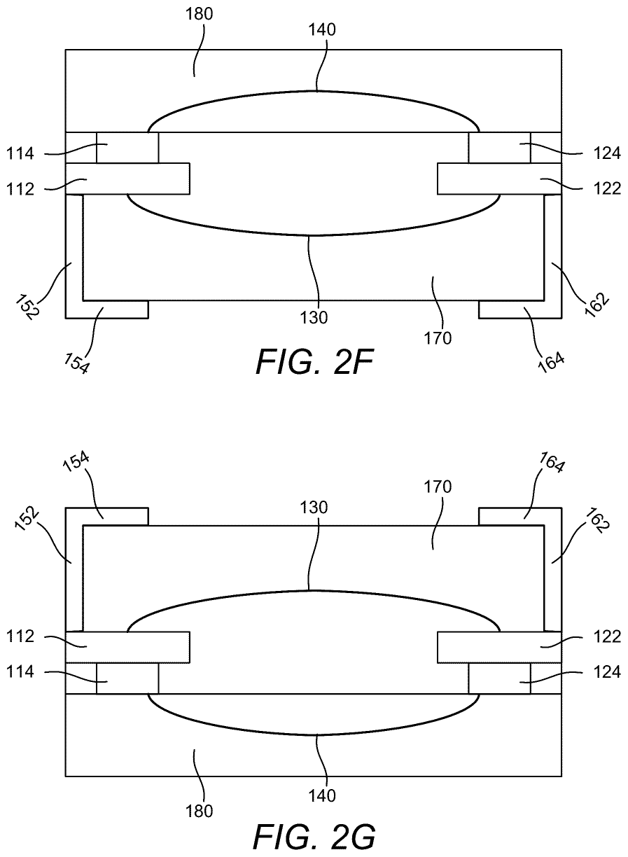

FIGS. 2A-2G illustrate example stages of fabricating a 3D inductor, such as the 3D inductor 100, in accordance with or more aspects of the disclosure. FIG. 2A illustrates a stage in which the first and second leads 110, 120 are formed. For example, first upper and lower leads 112, 114 may be formed on a first side, and second upper and lower leads 122, 124 may be formed on a second side.

FIG. 2B illustrates a stage in which upper wires 130 may be bonded to the upper surfaces of the first and second leads 110, 120 (e.g., upper surfaces of first and second upper leads 112, 122).

FIG. 2C illustrates a stage in which the first leads 110, the second leads 120, and the upper wires 130 may be molded with the upper mold 170 (e.g., with the first magnetic molding compound). The sides of the upper mold 170 may then be etched (e.g., with etchant or laser drilling) to expose portions of the leads that represent ends of the inductor loops. For example, a portion of an upper surface of a first of the first leads 110 may be exposed. Also, a portion of an upper surface of a last of the second leads 120 may be exposed (e.g., when N=M). Alternatively (e.g., when N M), a portion of an upper surface of a last of the first leads 110 may be exposed (not shown).

FIG. 2D illustrates a stage in which first and second terminals 150, 160 are formed. For example, first side plate 152 and first pad 154 may be printed or plated. Also, second side plate 162 and second pad 155 may be printed or plated.

FIG. 2E illustrates a stage in which the structure is flipped and the lower wires 140 may be bonded to the lower surfaces of the first and second leads 110, 120 (e.g., lower surfaces of first and second lower leads 114, 124).

FIG. 2F illustrates a stage in which the lower wires 140 may be molded with the lower mold 180 (e.g., with the second magnetic molding compound).

In an aspect, multiple 3D inductors 100 may be fabricated, e.g., on a lead frame. FIG. 2G illustrates a stage in which dicing or sawing may be performed to form individual 3D inductors 100.

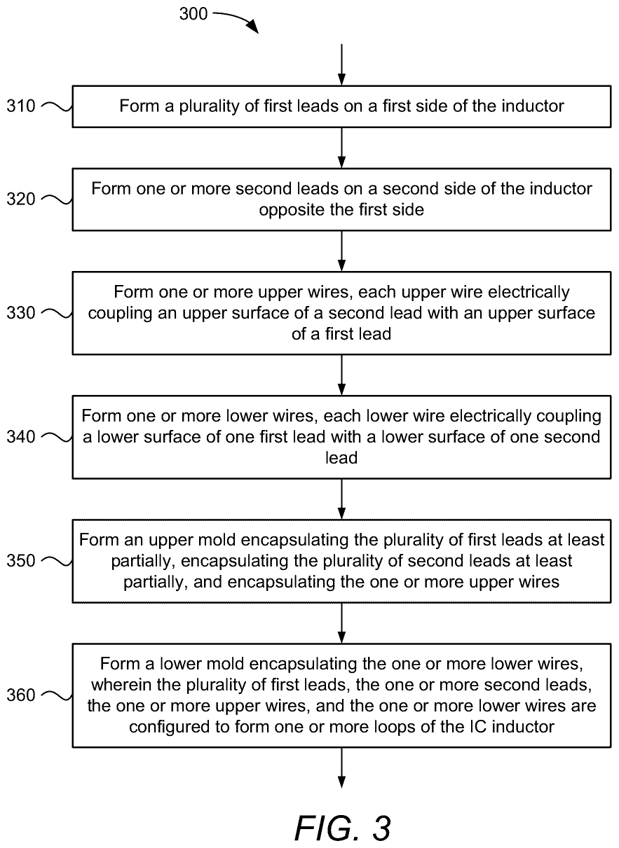

FIG. 3 illustrates a flow chart of an example method 300 of fabricating a 3D inductor, such as 3D inductor 100, in accordance with at one or more aspects of the disclosure.

In block 310, a plurality of first leads 110 may be formed on a first side of the inductor 100. Block 310 may correspond to the stage illustrated in FIG. 2A.

In block 320, one or more second leads 120 may be formed on a second side of the inductor 100 opposite the first side. Block 320 may correspond to the stage illustrated in FIG. 2A.

In block 330, one or more upper wires 130 may be formed. Each upper wire 130 may electrically couple an upper surface of a second lead 120 with an upper surface of a first lead 110. Block 330 may correspond to the stage illustrated in FIG. 2B.

In block 340, one or more lower wires 140 may be formed. Each lower wire 140 may electrically couple a lower surface of one first lead 110 with a lower surface of one second lead 120. Block 340 may correspond to the stage illustrated in FIG. 2E.

In block 350, an upper mold 170 may be formed. The upper mold 170 may encapsulate the plurality of first leads 110 at least partially, encapsulate the plurality of second leads 120 at least partially, and encapsulate the one or more upper wires 130. Block 350 may correspond to the stage illustrated in FIG. 2C.

In block 360, a lower mold 180 may be formed. The lower mold 180 may encapsulate the one or more lower wires 140. Block 360 may correspond to the stage illustrated in FIG. 2F.

Note that the plurality of first leads 110, the one or more second leads 120, the one or more upper wires 130, and the one or more lower wires 140 may be configured to form one or more loops of the 3D inductor 100.

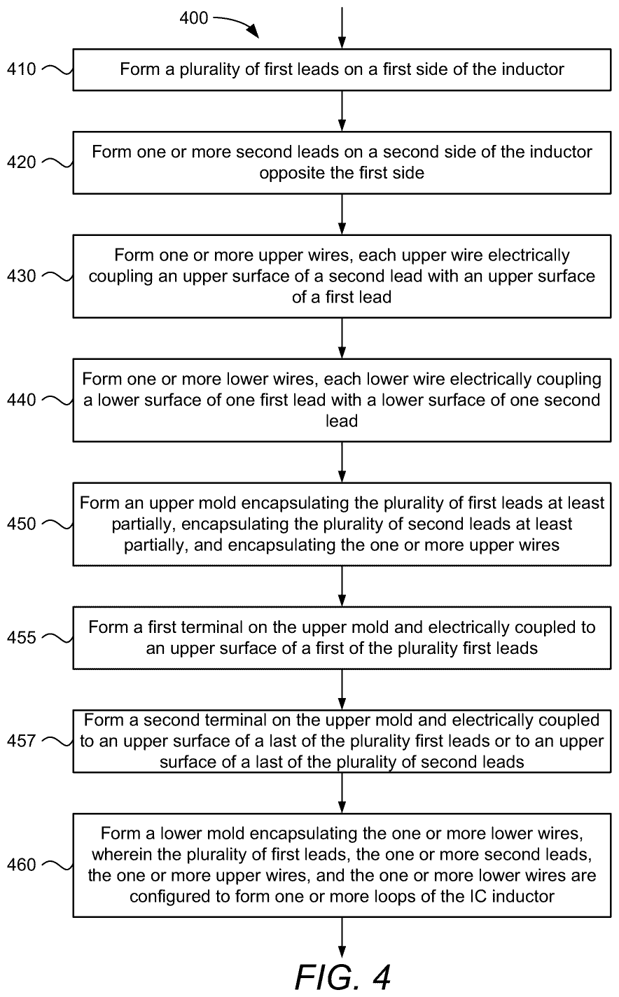

FIG. 4 illustrates a flow chart of an example method 400 of fabricating a 3D inductor, such as 3D inductor 100, in accordance with at one or more aspects of the disclosure. FIG. 4 may be view as being more comprehensive than FIG. 3.

Block 410 may be similar to block 310. That is, in block 410, a plurality of first leads 110 may be formed on a first side of the inductor 100. Block 410 may correspond to the stage illustrated in FIG. 2A.

Block 420 may be similar to block 320. That is, in block 420, one or more second leads 120 may be formed on a second side of the inductor 100 opposite the first side. Block 420 may correspond to the stage illustrated in FIG. 2A.

Block 430 may be similar to block 330. That is, in block 430, one or more upper wires 130 may be formed. Each upper wire 130 may electrically couple an upper surface of a second lead 120 with an upper surface of a first lead 110. Block 430 may correspond to the stage illustrated in FIG. 2B.

Block 440 may be similar to block 340. That is, in block 440, one or more lower wires 140 may be formed. Each lower wire 140 may electrically couple a lower surface of one first lead 110 with a lower surface of one second lead 120. Block 440 may correspond to the stage illustrated in FIG. 2E.

Block 450 may be similar to block 350. That is, in block 450, an upper mold 170 may be formed. The upper mold 170 may encapsulate the plurality of first leads 110 at least partially, encapsulate the plurality of second leads 120 at least partially, and encapsulate the one or more upper wires 130. Block 450 may correspond to the stage illustrated in FIG. 2C.

In block 455, first terminal 150 may be formed on the upper mold 170. The first terminal 150 may be electrically coupled to an upper surface of a first of the plurality of first leads 110, e.g., to the upper surface of first lead 1. Block 455 may correspond to the stage illustrated in FIG. 2D.

In block 457, second terminal 160 may be formed on the upper mold 170. The second terminal 160 may be electrically coupled to an upper surface of a last of the plurality of first leads 110, e.g., to the upper surface of first lead N (not shown). Alternatively, the second terminal 160 may be electrically coupled to an upper surface of a last of the plurality of second leads 120, e.g., to the upper surface of second lead M. Block 457 may correspond to the stage illustrated in FIG. 2D.

Block 460 may be similar to block 360. That is, in block 460, a lower mold 180 may be formed. The lower mold 180 may encapsulate the one or more lower wires 140. Block 460 may correspond to the stage illustrated in FIG. 2F.

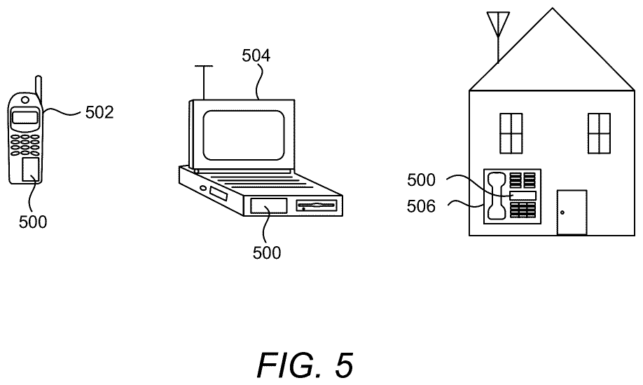

FIG. 5 illustrates various electronic devices 500 that may be integrated with any of the aforementioned 3D inductors in accordance with various aspects of the disclosure. For example, a mobile phone device 502, a laptop computer device 504, and a fixed location terminal device 506 may each be considered generally user equipment (UE) and may include one or more 3D inductors as described herein. The devices 502, 504, 506 illustrated in FIG. 5 are merely exemplary. Other electronic devices may also include the die packages including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), an Internet of things (IoT) device or any other device that stores or retrieves data or computer instructions or any combination thereof.

The foregoing disclosed devices and functionalities may be designed and configured into computer files (e.g., RTL, GDSII, GERBER, etc.) stored on computer-readable media. Some or all such files may be provided to fabrication handlers who fabricate devices based on such files. Resulting products may include semiconductor wafers that are then cut into semiconductor die and packaged into an antenna on glass device. The antenna on glass device may then be employed in devices described herein.

Implementation examples are described in the following numbered clauses:

Clause 1: A three-dimensional (3D) inductor, comprising: a plurality of first leads on a first side of the inductor; one or more second leads on a second side of the inductor opposite the first side; one or more upper wires, each upper wire electrically coupling an upper surface of a second lead with an upper surface of a first lead; one or more lower wires, each lower wire electrically coupling a lower surface of one first lead with a lower surface of one second lead; an upper mold at least partially encapsulating the plurality of first leads and at least partially encapsulating the plurality of second leads and encapsulating the one or more upper wires; and a lower mold encapsulating the one or more lower wires, wherein the plurality of first leads, the one or more second leads, the one or more upper wires, and the one or more lower wires are configured to form one or more loops of the 3D inductor.

Clause 2: The 3D inductor of clause 1, further comprising: a first terminal on the upper mold and electrically coupled to an upper surface of a first of the plurality first leads; and a second terminal on the upper mold and electrically coupled to an upper surface of a last of the plurality first leads or to an upper surface of a last of the plurality of second leads.

Clause 3: The 3D inductor of clause 2, wherein a number of first leads is N, N=2 or higher, wherein a number of second leads is M=N, wherein a number of upper wires is N−1, each upper wire electrically coupling an upper surface of a second lead (k) to an upper surface a first lead (k+1), k=1 . . . N−1, and wherein a number of lower wires is M, each lower wire electrically coupling a lower surface of a first lead (j) to a lower surface of a second lead (j), j=1 . . . M.

Clause 4: The 3D inductor of clause 3, wherein the second terminal is electrically coupled to the upper surface of the second lead (M).

Clause 5: The 3D inductor of clause 2, wherein a number of first leads is N, N=2 or higher, wherein a number of second leads is M=N−1, wherein a number of upper wires is N−1, each upper wire electrically coupling an upper surface of a second lead (k) to an upper surface a first lead (k+1), k=1 . . . N−1, and wherein a number of lower wires is M, each lower wire electrically coupling a lower surface of a first lead (j) to a lower surface of a second lead (j), j=1 . . . M.

Clause 6: The 3D inductor of clause 5, wherein the second terminal is electrically coupled to the upper surface of the first lead (N).

Clause 7: The 3D inductor of any of clauses 2-6, wherein the first terminal comprises: a first side plate formed on a side surface of the upper mold, a lower part of the first side plate being in contact with the upper surface of the first of the plurality of first leads; and a first pad formed on an upper surface of the upper mold and connected with the first side plate.

Clause 8: The 3D inductor of any of clauses 2-7, wherein the second terminal comprises: a second side plate formed on a side surface of the upper mold, a lower part of the second side plate being in contact with the upper surface of the last of the plurality of first leads or with the upper surface of the last of the plurality of second leads; and a second pad formed on an upper surface of the upper mold and connected with the second side plate.

Clause 9: The 3D inductor of any of clauses 2-8, wherein the first terminal is formed from any one or more a copper, silver, and aluminum, wherein the second terminal is formed from any one or more a copper, silver, and aluminum, or both.

Clause 10: The 3D inductor of any of clauses 1-9, wherein the upper mold is formed from a first magnetic molding compound, wherein the lower mold is formed from a second magnetic molding compound, or both.

Clause 11: The 3D inductor of clause 10, wherein the first magnetic molding compound is any one or more of polymer bonded compound, ferrite-bonded compound, isotropic neodymium bonded compound, anisotropic isotropic neodymium-bonded compound, and samarium-cobalt bonded compound, wherein the second magnetic molding compound is any one or more of polymer bonded compound, ferrite-bonded compound, isotropic neodymium bonded compound, anisotropic isotropic neodymium-bonded compound, and samarium-cobalt bonded compound, or both.

Clause 12: The 3D inductor of any of clauses 1-11, wherein the plurality of first leads comprises a plurality of first upper leads and a plurality of first lower leads, each first upper lead being on a corresponding first lower lead, upper surfaces of the plurality of first upper leads being the upper surfaces of the plurality of first leads, and lower surfaces of the plurality of first lower leads being the lower surfaces of the first leads, wherein the plurality second leads comprises a plurality of second upper leads and a plurality of second lower leads, each second upper lead being on a corresponding second lower lead, upper surfaces of the plurality of second upper leads being the upper surfaces of the plurality of second leads, and lower surfaces of the plurality of second lower leads being the lower surfaces of the second leads, or both.

Clause 13: The 3D inductor of clause 12, wherein the plurality first upper leads is formed from any one or more of copper, silver, and aluminum, wherein the plurality first lower leads is formed from any one or more of copper, silver, and aluminum, wherein the plurality second upper leads is formed from any one or more of copper, silver, and aluminum, wherein the plurality second lower leads is formed from any one or more of copper, silver, and aluminum, or any combination of thereof.

Clause 14: The 3D inductor of any of clauses 1-13, wherein the one or more upper wires are formed from any one or more of copper, aluminum, gold, and silver, wherein the one or more lower wires are formed from any one or more of copper, aluminum, gold, and silver, or both.

Clause 15: The 3D inductor of any of clauses 1-14, wherein the 3D inductor is incorporated into an apparatus selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, an Internet of things (IoT) device, a laptop computer, a server, and a device in an automotive vehicle.

Clause 16: A method of fabricating a three-dimensional (3D) inductor, the method comprising: forming a plurality of first leads on a first side of the inductor; forming one or more second leads on a second side of the inductor opposite the first side; forming one or more upper wires, each upper wire electrically coupling an upper surface of a second lead with an upper surface of a first lead; forming one or more lower wires, each lower wire electrically coupling a lower surface of one first lead with a lower surface of one second lead; forming an upper mold at least partially encapsulating the plurality of first leads and at least partially encapsulating the plurality of second leads and encapsulating the one or more upper wires; and forming a lower mold encapsulating the one or more lower wires, wherein the plurality of first leads, the one or more second leads, the one or more upper wires, and the one or more lower wires are configured to form one or more loops of the 3D inductor.

Clause 17: The method of clause 16, further comprising: forming a first terminal on the upper mold and electrically coupled to an upper surface of a first of the plurality first leads; and forming a second terminal on the upper mold and electrically coupled to an upper surface of a last of the plurality first leads or to an upper surface of a last of the plurality of second leads.

Clause 18: The method of clause 17, wherein a number of first leads is N, N=2 or higher, wherein a number of second leads is M=N, wherein a number of upper wires is N−1, each upper wire electrically coupling an upper surface of a second lead (k) to an upper surface a first lead (k+1), k=1 . . . N−1, and wherein a number of lower wires is M, each lower wire electrically coupling a lower surface of a first lead (j) to a lower surface of a second lead (j), j=1 . . . M.

Clause 19: The method of clause 18, wherein the second terminal is electrically coupled to the upper surface of the second lead (M).

Clause 20: The method of clause 17, wherein a number of first leads is N, N=2 or higher, wherein a number of second leads is M=N−1, wherein a number of upper wires is N−1, each upper wire electrically coupling an upper surface of a second lead (k) to an upper surface a first lead (k+1), k=1 . . . N−1, and wherein a number of lower wires is M, each lower wire electrically coupling a lower surface of a first lead (j) to a lower surface of a second lead (j), j=1 . . . M.

Clause 21: The method of clause 20, wherein the second terminal is electrically coupled to the upper surface of the first lead (N).

Clause 22: The method of any of clauses 17-21, wherein the first terminal comprises: a first side plate formed on a side surface of the upper mold, a lower part of the first side plate being in contact with the upper surface of the first of the plurality of first leads; and a first pad formed on an upper surface of the upper mold and connected with the first side plate.

Clause 23: The method of any of clauses 17-22, wherein the second terminal comprises: a second side plate formed on a side surface of the upper mold, a lower part of the second side plate being in contact with the upper surface of the last of the plurality of first leads or with the upper surface of the last of the plurality of second leads; and a second pad formed on an upper surface of the upper mold and connected with the second side plate.

Clause 24: The method of any of clauses 17-23, wherein the first terminal is formed from any one or more a copper, silver, and aluminum, wherein the second terminal is formed from any one or more a copper, silver, and aluminum, or both.

Clause 25: The method of any of clauses 16-24, wherein the upper mold is formed from a first magnetic molding compound, wherein the lower mold is formed from a second magnetic molding compound, or both.

Clause 26: The method of clause 25, wherein the first magnetic molding compound is any one or more of polymer bonded compound, ferrite-bonded compound, isotropic neodymium bonded compound, anisotropic isotropic neodymium-bonded compound, and samarium-cobalt bonded compound, wherein the second magnetic molding compound is any one or more of polymer bonded compound, ferrite-bonded compound, isotropic neodymium bonded compound, anisotropic isotropic neodymium-bonded compound, and samarium-cobalt bonded compound, or both.

Clause 27: The method of any of clauses 16-26, wherein the plurality of first leads comprises a plurality of first upper leads and a plurality of first lower leads, each first upper lead being on a corresponding first lower lead, upper surfaces of the plurality of first upper leads being the upper surfaces of the plurality of first leads, and lower surfaces of the plurality of first lower leads being the lower surfaces of the first leads, wherein the plurality second leads comprises a plurality of second upper leads and a plurality of second lower leads, each second upper lead being on a corresponding second lower lead, upper surfaces of the plurality of second upper leads being the upper surfaces of the plurality of second leads, and lower surfaces of the plurality of second lower leads being the lower surfaces of the second leads, or both.

Clause 28: The method of clause 27, wherein the plurality first upper leads is formed from any one or more of copper, silver, and aluminum, wherein the plurality first lower leads is formed from any one or more of copper, silver, and aluminum, wherein the plurality second upper leads is formed from any one or more of copper, silver, and aluminum, wherein the plurality second lower leads is formed from any one or more of copper, silver, and aluminum, or any combination of thereof.

Clause 29: The method of any of clauses 16-28, wherein the one or more upper wires are formed from any one or more of copper, aluminum, gold, and silver, wherein the one or more lower wires are formed from any one or more of copper, aluminum, gold, and silver, or both.

As used herein, the terms “user equipment” (or “UE”), “user device,” “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can receive wireless communication and/or navigation signals. These terms include, but are not limited to, a music player, a video player, an entertainment unit, a navigation device, a communications device, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). These terms are also intended to include devices which communicate with another device that can receive wireless communication and/or navigation signals such as by short-range wireless, infrared, wireline connection, or other connection, regardless of whether satellite signal reception, assistance data reception, and/or position-related processing occurs at the device or at the other device. In addition, these terms are intended to include all devices, including wireless and wireline communication devices, that are able to communicate with a core network via a radio access network (RAN), and through the core network the UEs can be connected with external networks such as the Internet and with other UEs. Of course, other mechanisms of connecting to the core network and/or the Internet are also possible for the UEs, such as over a wired access network, a wireless local area network (WLAN) (e.g., based on IEEE 802.11, etc.) and so on. UEs can be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE), 5G New Radio, Bluetooth (BT), Bluetooth Low Energy (BLE), IEEE 802.11 (WiFi), and IEEE 802.15.4 (Zigbee/Thread) or other protocols that may be used in a wireless communications network or a data communications network. Bluetooth Low Energy (also known as Bluetooth LE, BLE, and Bluetooth Smart) is a wireless personal area network technology designed and marketed by the Bluetooth Special Interest Group intended to provide considerably reduced power consumption and cost while maintaining a similar communication range. BLE was merged into the main Bluetooth standard in 2010 with the adoption of the Bluetooth Core Specification Version 4.0 and updated in Bluetooth 5.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described herein can be configured to perform at least a portion of a method described herein.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element unless the connection is expressly disclosed as being directly connected.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Nothing stated or illustrated depicted in this application is intended to dedicate any component, action, feature, benefit, advantage, or equivalent to the public, regardless of whether the component, action, feature, benefit, advantage, or the equivalent is recited in the claims.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or one or more claims—other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions and/or functionalities of the methods disclosed.

Furthermore, in some examples, an individual action can be subdivided into one or more sub-actions or contain one or more sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A three-dimensional (3D) inductor, comprising:
a plurality of first leads on a first side of the inductor;
one or more second leads on a second side of the inductor opposite the first side;
one or more upper wires, each upper wire electrically coupling an upper surface of a second lead with an upper surface of a first lead;
one or more lower wires, each lower wire electrically coupling a lower surface of one first lead with a lower surface of one second lead;
an upper mold at least partially encapsulating the plurality of first leads and at least partially encapsulating the plurality of second leads and encapsulating the one or more upper wires; and
a lower mold encapsulating the one or more lower wires,
wherein the plurality of first leads, the one or more second leads, the one or more upper wires, and the one or more lower wires are configured to form one or more loops of the 3D inductor.

2. The 3D inductor of claim 1, further comprising:
a first terminal on the upper mold and electrically coupled to an upper surface of a first of the plurality first leads; and
a second terminal on the upper mold and electrically coupled to an upper surface of a last of the plurality first leads or to an upper surface of a last of the plurality of second leads.

3. The 3D inductor of claim 2,
wherein a number of first leads is N, N=2 or higher,
wherein a number of second leads is M=N,
wherein a number of upper wires is N−1, each upper wire electrically coupling an upper surface of a second lead (k) to an upper surface a first lead (k+1), k=1 . . . N−1, and
wherein a number of lower wires is M, each lower wire electrically coupling a lower surface of a first lead (j) to a lower surface of a second lead (j), j=1 . . . M.

4. The 3D inductor of claim 3, wherein the second terminal is electrically coupled to the upper surface of the second lead (M).

5. The 3D inductor of claim 2,
wherein a number of first leads is N, N=2 or higher,
wherein a number of second leads is M=N−1,
wherein a number of upper wires is N−1, each upper wire electrically coupling an upper surface of a second lead (k) to an upper surface a first lead (k+1), k=1 . . . N−1, and
wherein a number of lower wires is M, each lower wire electrically coupling a lower surface of a first lead (j) to a lower surface of a second lead (j), j=1 . . . M.

6. The 3D inductor of claim 5, wherein the second terminal is electrically coupled to the upper surface of the first lead (N).

7. The 3D inductor of claim 2, wherein the first terminal comprises:
a first side plate formed on a side surface of the upper mold, a lower part of the first side plate being in contact with the upper surface of the first of the plurality of first leads; and
a first pad formed on an upper surface of the upper mold and connected with the first side plate.

8. The 3D inductor of claim 2, wherein the second terminal comprises:
a second side plate formed on a side surface of the upper mold, a lower part of the second side plate being in contact with the upper surface of the last of the plurality of first leads or with the upper surface of the last of the plurality of second leads; and
a second pad formed on an upper surface of the upper mold and connected with the second side plate.

9. The 3D inductor of claim 2,
wherein the first terminal is formed from any one or more a copper, silver, and aluminum,
wherein the second terminal is formed from any one or more a copper, silver, and aluminum, or
both.

10. The 3D inductor of claim 1,
wherein the upper mold is formed from a first magnetic molding compound,
wherein the lower mold is formed from a second magnetic molding compound, or both.

11. The 3D inductor of claim 10,
wherein the first magnetic molding compound is any one or more of polymer bonded compound, ferrite-bonded compound, isotropic neodymium bonded compound, anisotropic isotropic neodymium-bonded compound, and samarium-cobalt bonded compound,
wherein the second magnetic molding compound is any one or more of polymer bonded compound, ferrite-bonded compound, isotropic neodymium bonded compound, anisotropic isotropic neodymium-bonded compound, and samarium-cobalt bonded compound, or
both.

12. The 3D inductor of claim 1,
wherein the plurality of first leads comprises a plurality of first upper leads and a plurality of first lower leads, each first upper lead being on a corresponding first lower lead, upper surfaces of the plurality of first upper leads being the upper surfaces of the plurality of first leads, and lower surfaces of the plurality of first lower leads being the lower surfaces of the first leads,
wherein the plurality second leads comprises a plurality of second upper leads and a plurality of second lower leads, each second upper lead being on a corresponding second lower lead, upper surfaces of the plurality of second upper leads being the upper surfaces of the plurality of second leads, and lower surfaces of the plurality of second lower leads being the lower surfaces of the second leads, or
both.

13. The 3D inductor of claim 12,
wherein the plurality first upper leads is formed from any one or more of copper, silver, and aluminum,
wherein the plurality first lower leads is formed from any one or more of copper, silver, and aluminum,
wherein the plurality second upper leads is formed from any one or more of copper, silver, and aluminum,
wherein the plurality second lower leads is formed from any one or more of copper, silver, and aluminum, or
any combination of thereof.

14. The 3D inductor of claim 1,
wherein the one or more upper wires are formed from any one or more of copper, aluminum, gold, and silver,
wherein the one or more lower wires are formed from any one or more of copper, aluminum, gold, and silver, or
both.

15. The 3D inductor of claim 1, wherein the 3D inductor is incorporated into an apparatus selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, an Internet of things (IoT) device, a laptop computer, a server, and a device in an automotive vehicle.

16. A method of fabricating a three-dimensional (3D) inductor, the method comprising:
forming a plurality of first leads on a first side of the inductor;
forming one or more second leads on a second side of the inductor opposite the first side;
forming one or more upper wires, each upper wire electrically coupling an upper surface of a second lead with an upper surface of a first lead;
forming one or more lower wires, each lower wire electrically coupling a lower surface of one first lead with a lower surface of one second lead;
forming an upper mold at least partially encapsulating the plurality of first leads and at least partially encapsulating the plurality of second leads and encapsulating the one or more upper wires; and
forming a lower mold encapsulating the one or more lower wires,
wherein the plurality of first leads, the one or more second leads, the one or more upper wires, and the one or more lower wires are configured to form one or more loops of the 3D inductor.

17. The method of claim 16, further comprising:
forming a first terminal on the upper mold and electrically coupled to an upper surface of a first of the plurality first leads; and
forming a second terminal on the upper mold and electrically coupled to an upper surface of a last of the plurality first leads or to an upper surface of a last of the plurality of second leads.

18. The method of claim 17,
wherein a number of first leads is N, N=2 or higher,
wherein a number of second leads is M=N,
wherein a number of upper wires is N−1, each upper wire electrically coupling an upper surface of a second lead (k) to an upper surface a first lead (k+1), k=1 . . . N−1, and
wherein a number of lower wires is M, each lower wire electrically coupling a lower surface of a first lead (j) to a lower surface of a second lead (j), j=1 . . . M.

19. The method of claim 18, wherein the second terminal is electrically coupled to the upper surface of the second lead (M).

20. The method of claim 17,
wherein a number of first leads is N, N=2 or higher,
wherein a number of second leads is M=N−1,
wherein a number of upper wires is N−1, each upper wire electrically coupling an upper surface of a second lead (k) to an upper surface a first lead (k+1), k=1 . . . N−1, and
wherein a number of lower wires is M, each lower wire electrically coupling a lower surface of a first lead (j) to a lower surface of a second lead (j), j=1 . . . M.

21. The method of claim 20, wherein the second terminal is electrically coupled to the upper surface of the first lead (N).

22. The method of claim 17, wherein the first terminal comprises:
a first side plate formed on a side surface of the upper mold, a lower part of the first side plate being in contact with the upper surface of the first of the plurality of first leads; and
a first pad formed on an upper surface of the upper mold and connected with the first side plate.

23. The method of claim 17, wherein the second terminal comprises:
a second side plate formed on a side surface of the upper mold, a lower part of the second side plate being in contact with the upper surface of the last of the plurality of first leads or with the upper surface of the last of the plurality of second leads; and
a second pad formed on an upper surface of the upper mold and connected with the second side plate.

24. The method of claim 17,
wherein the first terminal is formed from any one or more a copper, silver, and aluminum,
wherein the second terminal is formed from any one or more a copper, silver, and aluminum, or
both.

25. The method of claim 16,
wherein the upper mold is formed from a first magnetic molding compound,
wherein the lower mold is formed from a second magnetic molding compound, or both.

26. The method of claim 25,
wherein the first magnetic molding compound is any one or more of polymer bonded compound, ferrite-bonded compound, isotropic neodymium bonded compound, anisotropic isotropic neodymium-bonded compound, and samarium-cobalt bonded compound,
wherein the second magnetic molding compound is any one or more of polymer bonded compound, ferrite-bonded compound, isotropic neodymium bonded compound, anisotropic isotropic neodymium-bonded compound, and samarium-cobalt bonded compound, or
both.

27. The method of claim 16,
wherein the plurality of first leads comprises a plurality of first upper leads and a plurality of first lower leads, each first upper lead being on a corresponding first lower lead, upper surfaces of the plurality of first upper leads being the upper surfaces of the plurality of first leads, and lower surfaces of the plurality of first lower leads being the lower surfaces of the first leads,
wherein the plurality second leads comprises a plurality of second upper leads and a plurality of second lower leads, each second upper lead being on a corresponding second lower lead, upper surfaces of the plurality of second upper leads being the upper surfaces of the plurality of second leads, and lower surfaces of the plurality of second lower leads being the lower surfaces of the second leads, or
both.

28. The method of claim 27,
wherein the plurality first upper leads is formed from any one or more of copper, silver, and aluminum,
wherein the plurality first lower leads is formed from any one or more of copper, silver, and aluminum,
wherein the plurality second upper leads is formed from any one or more of copper, silver, and aluminum,
wherein the plurality second lower leads is formed from any one or more of copper, silver, and aluminum, or
any combination of thereof.

29. The method of claim 16,
wherein the one or more upper wires are formed from any one or more of copper, aluminum, gold, and silver,
wherein the one or more lower wires are formed from any one or more of copper, aluminum, gold, and silver, or
both.
